(19) United States
(12) Patent Application Publication
(10) Pub. No.: US 2005/0012278 A1
(43) Pub. Date: Jan. 20, 2005

(54) Metal sleeve seal for threaded connections

(76) Inventor: Richard W. DeLange, Kingwood, TX (US)

Correspondence Address: BROWNING BUSHMAN, P.C., Suite 1800, 5718 Westheimer, Houston, TX, 77057, US

(21) Appl. No.: 10/840,996

(22) Filed: May 7, 2004

Related U.S. Application Data
(63) Continuation-in-part of application No. 10/290,003, filed on Nov. 7, 2002.

(51) Int. Cl. F16L 17/00

(52) U.S. Cl. 277/602

(57) ABSTRACT

A threaded tubular connection having a sleeve seal for maintaining pressure sealing capabilities within the connection when exposed to extreme pressure and/or temperature variations. The sleeve seal forms a third part of the pin and box connection and is positioned axially intermediate the ends of the threaded engagement of the connection. The sleeve seal is constructed of a corrosion resistant metal having a Modulus of Elasticity and thermal characteristics that work with the Modulus of Elasticity and the thermal characteristics of the pin and box material to minimize leakage following exposure to extremes of pressure differentials and temperature.

### CROSS REFERENCE TO RELATED APPLICATIONS

This application is a continuation-in-part of U.S. patent application Ser. No. 10/290,003 filed Nov. 7, 2002, the disclosure of which is incorporated herein by reference, and assigned to the Assignee of the present application.

### FIELD OF THE INVENTION

The present invention relates generally to threaded connections used to seal and secure together cylindrical members. More specifically, the present invention relates to threaded tubular members having sleeve seals for enhancing the pressure sealing ability of an engaged threaded pipe connection.

### BACKGROUND SETTING OF THE PRIOR ART

Threaded pipe connections used in the construction of hydrocarbon producing wells are being increasingly called upon to maintain pressure seals against very high-pressure differentials. The high-pressure side of the seal may be on the internal side of the connection or may be on the external side of the connection, or may alternate between the internal and external sides of the connection. The problem of withstanding these high internal and external pressure differentials is compounded when the requirements of a particular well construction call for a relatively thin-walled connection.

The external dimensions of many threaded connections are maintained small by employing a “flush joint” design, which ensures that the outside diameter of the connection at the end of a tube body is the same as, or is not significantly greater than, the outside diameter of the tube body itself. Maintaining the largest flow diameter through a flush joint connection also requires that the radial thickness of the connection be substantially the same as the radial thickness of the tube body. This results in a thin wall connection.

In many flush joint connections, the smallest radial diameters of the components making up the connection occur near the nose of the pin and near the face of the box. Sealing that occurs in the areas of the smallest radial cross sectional dimensions imposes radial forces against the component member with the small wall thickness that can cause permanent deformation of the component. Such connections, when deformed after being exposed to a high-pressure differential, are rendered ineffective in subsequently sealing against smaller pressure differentials. This situation may occur, for example, when a connection in a string of pipe is deformed during testing to a pressure above the anticipated working pressure of the string. Abnormal pressure differentials can also deform, or otherwise render inoperative, resilient seals that are positioned within the connection.

The problems associated with connections being subjected to high pressures have become more severe with the introduction of the new testing formats introduced by the International Organization for Standardization (ISO) and the American Petroleum Institute (API). The new ISO testing format (ISO 13679), requires performance verification testing of connections for downhole applications. These tests are very rigorous and more severe than the API RP5C5 formats that ISO 13679 replaced. One of the more severe parts of the ISO format is reverse pressure testing of the connection that requires repeated alternating of the applied highest test pressure from internal to external.

When internal or external pressure is applied that is equal to the pipe body capabilities, as may be required by some test procedures, the seal area on the thinnest component of the connection can be permanently deformed causing its sealing ability to be lost when the pressure is reversed. In these situations, a relatively higher internal test pressure can yield the external seal element on the box near the outside end of the connection and the external pressure can produce the same damage on the internal seal element on the pin near the inside end of the connection.

A solution that has been employed in the past to avoid the distortion of thin seal areas in thin wall connections has been to provide a metal sealing engagement near the center of the connection, between two threaded steps. Often, such metal-to-metal seals at the center of the connection are slightly tapered so that they can be firmly engaged radially during the makeup process without undergoing significant rotating contact against each other. The rotating contact that occurs between such metal-to-metal seals is a primary cause of galling of the seal surfaces, which can cause the seals to leak. Tapered seals, however, are sensitive to applied tension loads that tend to pull the seals apart, causing the contact pressure between the metal-to-metal seals to be reduced, which in turn reduces the sealing ability of the connection.

The prior art has also taught the use of metal seal rings that are disposed within grooves formed in the threaded area of the connection. Such seal rings are designed to be cut by the threads of the pin or box component to which they are being engaged. The seal created by such connections is not capable of withstanding the high-pressure differentials required of modern-day connections.

Another solution proposed for handling extremes of pressure and/or temperature is the use of resilient (non-metal) materials to form an annular seal ring in the steel connection. Resilient seal rings, which are often made of polytetrachloroethylene (PTFE) or fiberglass, however, have thermal expansion characteristics that are drastically different from those of steel. As a result, when subjected to downhole temperatures common to deep gas wells or geothermal wells, the resilient ring expands significantly more than the steel. This difference in expansion can push apart the metal seal components in the region directly adjacent to the seal ring. When this occurs, the resilient seal ring can reduce the effectiveness of the metal seal.

### SUMMARY OF THE INVENTION

The present invention permits a connection to be tested under ISO 13679 without leaking, even after exposure to high pressure and/or high temperature differentials, or high amounts of tension or compression. A sleeve seal, which forms a third part of the connection, acts with the pin and box to form a seal that resists deformation during high pressure or high temperature exposure, minimizes galling during makeup and prevents pressure sealing reduction during tension loading.

The material of the sleeve seal is preferably a corrosion resistant metal having thermal characteristics that work with the thermal characteristics of the pin and box material to minimize bearing pressure reduction between engaged surfaces resulting from thermal changes.

A preferred form of the sleeve seal is constructed of a material with characteristics that render the sleeve seal more flexible than the material of the pin and box. By way of example, the steel frequently used in the pin and box construction of conventional oil field tubulars has a Modulus of Elasticity of approximately 30,000,000. When the present invention employs a sleeve seal constructed of titanium, which has a Modulus of Elasticity of approximately 15,000,000, the change in shape of the titanium sleeve may be twice as great as that of the pin and box, permitting an increase in the allowed pressure deformation of the connection as compared with that of a connection using a sleeve seal constructed of the same material as that of the pin and box.

The sleeve seal of the present invention, in addition to having a higher Modulus of Elasticity than that of the pin and/or box of the connection, may also be configured in a specific form to best accommodate the specifics of a particular application. Thus, it may be desirable to locate the seal sleeve at an axial position between the engaged pin and box connections at which the cross sectional radial dimension of the box is less than that of the pin in situations where the external pressure is expected to be abnormally high relative to the internal pressure. The cross sectional radial dimension of the pin at the sleeve seal may be less than that of the box at the axial position of the sleeve seal when the reverse pressure is anticipated. In either situation, the seal may be positioned at a point within the connection that will minimize the possibility of permanent yielding of either component of the connection as a result of exposure to unusually high-pressure differentials.

While the preferred form of the invention is intended for use in a relatively thin wall connection design, in which the connection wall is substantially the same thickness as the tube wall, it will be appreciated that the invention has applicability to any connection design including those in which the external or internal connection dimensions differ from the tube dimensions.

In view of the foregoing, it will be appreciated that a primary object of the present invention is to provide a seal for a threaded connection that can be exposed to extremes of temperature and pressure without losing the ability to maintain a seal at higher or lower temperatures and/or pressures.

Another object of the present invention is to provide a seal for a threaded connection that can be exposed to extremes of both internal or external pressure differentials while maintaining its ability to seal against smaller pressure differentials.

Yet another object of the present invention is to provide a seal for a threaded connection that maintains its ability to seal against pressure differentials acting across the connection as the connection is being exposed to extreme temperature variations.

A related object of the present invention is to provide a seal for a threaded connection in which a seal is maintained against internal or external pressures acting on the connection during, and following, the application to the seal of repeated variations between extremes of high internal pressure and high external pressure.

An important object of the present invention is to provide a high pressure and high temperature resistive seal that remains effective in a connection of the type having external and internal dimensions that are substantially the same as the internal and external dimensions of the tubes secured together by the connection.

An object of the present invention is to provide a sleeve seal insert near the center of a two-step connection such that engaged threads in the pin and box of the connection will be present on either axial side of the seal insert to assist in providing more contact pressure between the sleeve seal and the engaged box and pin members.

The foregoing features, advantages and objects of the present invention, as well as others will be more fully understood and better appreciated by reference to the following drawings, specification and claims.

### BRIEF DESCRIPTION OF THE DRAWINGS

FIG. 1 is a quarter sectional view of a connector of the present invention having an annular sleeve seal disposed between a pin and box of a threaded connection; and

FIGS. 1A-1F are alternative cross-sectional designs for an annular sleeve seal of the present invention that may be used in a connection between a threaded pin and box.

### DESCRIPTION OF THE ILLUSTRATED EMBODIMENTS

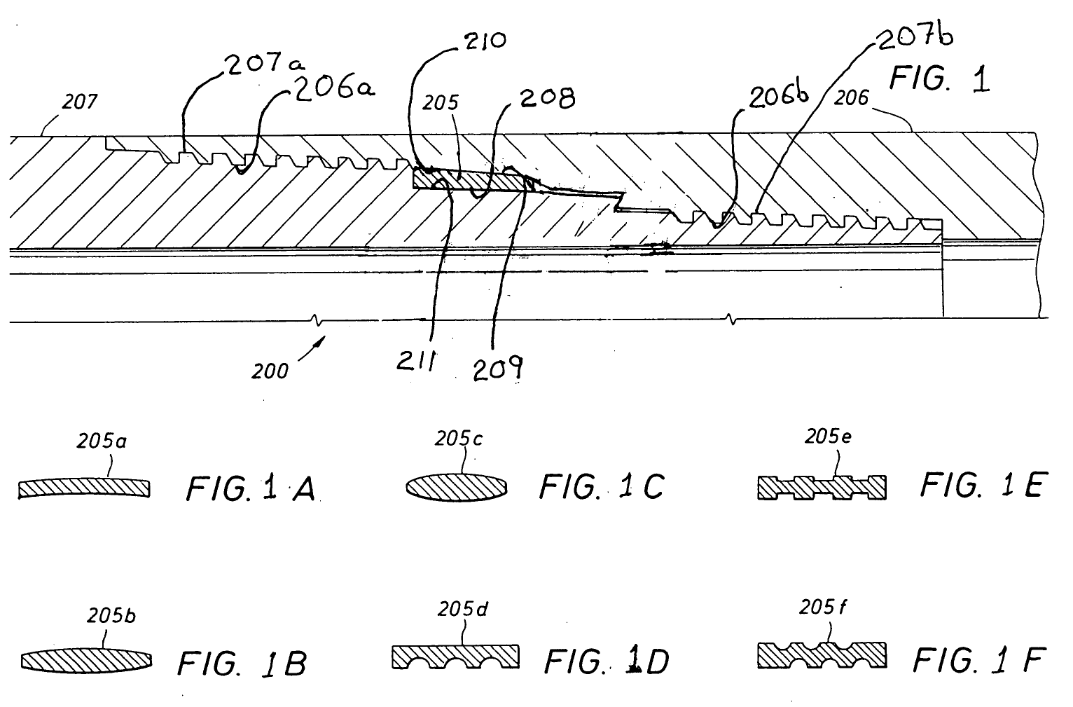

FIG. 1 illustrates a thin wall form of the connector of the present invention indicated generally at 200. A metal sleeve seal element 205 is positioned axially between two-step threads forming a threadedly engaged connection comprising a box 206 and pin 207. The two-step threads of the box 206 are formed by the box threads 206a and 206b. The two-step threads of the pin 207 are formed by the pin threads 207a and 207b. Shouldering engagement at the full makeup position is illustrated as occurring at the base of the box 206 and at the nose of the pin 207 as well as along a central shoulder located between the two-step threads. Any, or all, of these points of shouldering engagement may be configured to provide no contact, or very minimal contact, or they may be configured to provide significant contact in which they may act as a major torque shoulder and/or seal.

The radially internal and radially external surfaces of the sleeve seal 205 are formed from radially spaced, parallel, frustoconical surfaces 208 and 209 defining an annular body with inside and outside diameters, respectively, that taper along the central axis of the sleeve seal. The diameters of the sleeve 205 decrease in size in a direction from the base of the pin to the tip of the pin.

An annular, tapering box sleeve area 210 is formed internally within the box 206 between the step threads 206a and 206b. The box threads are thus seen to extend axially away from the box sleeve area 210 on either axial side of the pin sleeve area. A second annular, tapering pin sleeve area 211 is formed externally around the pin 207 between the pin step threads 207a and 207b. The pin threads are also seen to extend axially away from the pin sleeve area 211.

The annular sleeve seal 205 is concentrically disposed radially between the pin sleeve area 211 and the box sleeve area 210 at a location where the sleeve seal is adapted to be compressed radially between the pin sleeve area and the box sleeve area when the connection is threadedly engaged at a full makeup position. As illustrated in FIG. 1, the axial ends of the sleeve areas enclosing the sleeve seal 205 may also be configured to provide axial compression of the sleeve seal 205 when the connection is made up to the full makeup position.

In a preferred form of the invention, the pin sleeve area and the box sleeve area are devoid of the threads that are used to hold the connection together against axial displacement. In its radially compressed condition, the annular sleeve seal 205 forms a sealing engagement between the unthreaded surrounding pin sleeve area and box sleeve area to provide a seal against high pressure differentials acting on either side of the sleeve that attempt to radially separate the engaged pin and box. Selection of a sleeve material with a higher Modulus of Elasticity than that of the material of the surrounding pin and box components ensures that the seal will be maintained against smaller pressure differentials even after the connection is exposed to high pressure differentials acting either externally or internally of the connector.

In operation, the long, thin, tapered metal sleeve 205 is positioned over the pin 207 before the pin is inserted into the box 206. The dimensions of the surfaces 210 and 211 contacting the sleeve 205 are preferably selected such that, at the full makeup position of the pin and box, the sleeve 205 is compressed radially, and/or axially, sufficiently between the surfaces to form a pressure seal with the pin and box components of the connection. During connection makeup, the sleeve seal 205 is preferably compressed sufficiently to create a pressure seal that is effective in sealing a pressure differential that is higher from either the external or internal directions.

It may be appreciated by reference to FIG. 1 that the sleeve seal 205 is disposed between the pin and box connections at a point where the cross sectional dimensions of the pin and box are substantially greater than those of the cross sections of the pin and box members adjacent their respective axial ends. The relative radial wall thickness of the pin or box connection at the point of the placement of the sleeve 205 may be determined as a function of the size and direction of the pressure differential to be sealed by the sleeve seal 205.

The sleeve seal 205 is preferably constructed from a metal with a Modulus of Elasticity that is substantially lower than that of carbon steel, such as titanium or copper-beryllium. A preferred form of the sleeve seal 205 is as illustrated in FIG. 1 with smooth, internal and external circumferential surfaces 211, 210 engaging sealing surfaces on both the underlying pin and surrounding box, respectively. Non-smooth surface configurations for the sealing surface areas 210 and 211 may also be employed as required to achieve specific objectives in the connection design.

FIG. 1A illustrates a modified cross-section design 205a for the seal 205 having substantially similar end diameters and an arcing section increasing in diameter toward the center of the seal between the two ends.

FIG. 1B illustrates a modified cross-section design 205b for the seal 205 having a lens-shaped configuration.

FIG. 1C illustrates a modified cross-section design 205c for the seal 205 having an elongate, oval cross-section.

FIG. 1D illustrates a modified cross-section design 205d for the seal 205 having a smooth external circumferential surface and an internal surface provided with semicircular annular grooves.

FIG. 1E illustrates a modified cross-section design 205e for the seal 205 in which both the internal and external circumferential surfaces of the seal are provided with annular, flat bottom grooves.

FIG. 1F illustrates a modified cross-section design 205f for the seal 205 in which curved annular grooves are provided on the internal and external circumferential surfaces of the seal with the grooves of the internal and external surfaces being offset axially relative to each other.

While illustrative and explanatory descriptions of the present invention have been made herein, it will be appreciated that various changes in the details of the construction and use of the illustrated and described embodiments may be made without departing from the spirit and scope of the invention, which is more generally defined in the following claims.

1. A threaded connection, comprising:
a pin member having external threads formed along an external surface of said pin member,
a box member having internal threads formed along an internal surface of said box member, said pin and box members adapted to be threadedly engaged together with said pin and box threads to a full makeup position to form a threaded connection,
an annular pin sleeve area disposed axially intermediate the axial ends of said pin threads whereby said pin threads extend axially away from said pin sleeve area on either axial side of said pin sleeve area,
an annular box sleeve area disposed axially intermediate the axial ends of said box threads whereby said box threads extend axially away from said box sleeve area on either axial side of said box sleeve area, said pin sleeve area and said box sleeve area being substantially concentrically disposed and at least partially axially coincident when said connection is threadedly engaged at said full makeup position wherein said pin and box threads on each axial side of said box and pin sleeve areas are engaged,
an annular sleeve seal for concentric disposition radially between said pin sleeve area and said box sleeve area, said annular sleeve seal being adapted to be compressed radially between said pin sleeve area and said box sleeve area when said connection is threadedly engaged at said full makeup position, and
said sleeve seal being constructed of a metal having a lower Modulus of Elasticity than that of the material forming the pin member or the box member whereby the sleeve seal forms a pressure sealing engagement between the pin member and the box member while exposed to high pressure differentials acting across said sleeve seal.

2. A threaded connection as defined in claim 1 wherein said sleeve seal is carried by said pin member before said connection is engaged at said full makeup position.

3. A threaded connection as defined in claim 1 wherein said sleeve seal has at least one frustoconical surface on its inner and/or outer circumferential surfaces.

4. A threaded connection as defined in claim 1 wherein said sleeve seal is compressed axially when said connection is threadedly engaged at said full makeup position.

5. A threaded connection as defined in claim 1 wherein said pin and box sleeve areas are disposed axially at, or in the near vicinity of, the largest cross sectional area formed by the pin and box when said connection is threadedly engaged at said full makeup position.

6. A threaded connection as defined in claim 1 wherein said pin threads comprise step threads having different diameters on either axial side of said pin sleeve area.

7. A threaded connection as defined in claim 6 wherein said pin threads include a shoulder disposed axially between said step threads.

8. A threaded connection as defined in claim 6 wherein said pin sleeve area includes an area devoid of threads.

9. A threaded connection as defined in claim 1 wherein said sleeve seal has two substantially similar end diameters and an arcing section increasing in diameter toward a center of said sleeve seal between said two end diameters.

10. A threaded connection as defined in claim 1 wherein said sleeve seal has a lens-shaped cross sectional configuration.

11. A threaded connection as defined in claim 1 wherein said sleeve seal has an elongate, oval cross-section.

12. A threaded connection as defined in claim 1 wherein said sleeve seal has a smooth external circumferential surface and an internal surface provided with semicircular annular grooves.

13. A threaded connection as defined in claim 1 wherein said sleeve seal has internal and external circumferential surfaces and wherein said both the internal and external circumferential surfaces are provided with annular, flat bottom grooves.

14. A threaded connection as defined in claim 1 wherein said sleeve seal has internal and external circumferential surfaces provided with annular grooves that are offset axially relative to each other.
